(19) United States
(12) Patent Application Publication
(10) Pub. No.: US 2019/0392520 A1
(43) Pub. Date: Dec. 26, 2019

(54) SYSTEMS AND METHODS FOR CONTINGENCY NET ASSET VALUE PRICING

(71) Applicant: JPMORGAN CHASE BANK, N.A., New York, NY (US)

(72) Inventors: Farhad FETRAT, New York, NY (US); Amit PATIL, Woodbridge, NJ (US); Jayant V. GOKHALE, Edison, NJ (US); Eugene CHERNOVETSKY, New York, NY (US); David PURICELLI, II, Medway, MA (US); Kirk TRIVETT, Hornchurch (GB); Mary-Frances BARRY, Charlestown, MA (US); Mark BRAKONIECKI, Charlestown, MA (US); Samantha BURGESS, Newton, MA (US); Shankaran KRISHNASWAMY, Plano, TX (US); Sreeram C. KOSARAJU, Piscataway, NJ (US); Wojtek WOLSKI, New York, NY (US); Alec SHANAHAN, Dedham, MA (US); Sunita GANDHI, Plano, TX (US)

(21) Appl. No.: 16/452,016

(22) Filed: Jun. 25, 2019

Related U.S. Application Data
(60) Provisional application No. 62/689,368, filed on Jun. 25, 2018.

(51) Int. Cl. G06Q 40/04

(52) U.S. Cl. CPC G06Q 40/04

(57) ABSTRACT

Systems and methods for contingency NAV pricing are disclosed. In one embodiment, in an information processing apparatus comprising at least one computer processor, a method for contingency Net Asset Value (cNAV) pricing may include (1) receiving a daily Net Asset Value (NAV) for a fund and performance data for a plurality of benchmarks; (2) selecting one of the plurality of benchmarks that has a benchmark performance that is similar to a fund performance of the fund for a period of time; (3) determining a correlation factor between the fund performance and the selected benchmark performance; and (4) calculating a cNAV based on a prior day's NAV for the fund, a movement for the selected benchmark, and the correlation factor in response to a daily NAV for the fund being unavailable.

### RELATED APPLICATIONS

This application claims the benefit of and priority to U.S. Provisional Patent Application Ser. No. 62/689,368, filed Jun. 25, 2018, the disclosure of which is hereby incorporated by reference in its entirety.

### BACKGROUND OF THE INVENTION

### 1. Field of the Invention

The present disclosure generally relates to systems and methods for contingency NAV pricing.

### 2. Description of the Related Art

The Net Asset Value Explain (NAV-X) program provides a detailed view into the contributors' to end-of-day fund valuation, which includes a determination of asset values, earnings (e.g., dividends or coupon payments), and costs due to imposed taxes or assessed fees. A custodian of a fund is required to provide an accurate NAV valuation daily. If the upstream systems that supply the detailed data to the program—such as the price of all assets and the total value of all income, expenses and assessments—fail, the custodian remains under obligation to value the fund. Should this happen, the previous day's NAV is generally provided.

Without having detailed fund data (e.g., Distributions, Expenses, Income, etc.) it is impossible to determine what the NAV should actually be. And, after the proper NAV is generated eventually, it is manually intensive for an operations team to determine any financial obligations based on any differences between the previous day's NAV and the proper NAV.

### SUMMARY OF THE INVENTION

Systems and methods for contingency NAV pricing are disclosed. In one embodiment, in an information processing apparatus comprising at least one computer processor, a method for contingency Net Asset Value (cNAV) pricing may include (1) receiving a daily Net Asset Value (NAV) for a fund and performance data for a plurality of benchmarks; (2) selecting one of the plurality of benchmarks that has a benchmark performance that is similar to a fund performance of the fund for a period of time; (3) determining a correlation factor between the fund performance and the selected benchmark performance; and (4) calculating a cNAV based on a prior day's NAV for the fund, a movement for the selected benchmark, and the correlation factor in response to a daily NAV for the fund being unavailable.

In one embodiment, the selected benchmark may include an index, a commonly-traded instrument, etc.

In one embodiment, the selected benchmark may be one of the S&P 500 Index, the Dow Jones Industrial Average, the Hang Seng Index, the Nikkei 225 Index, the FTSE 100 Index, the DAX Index, etc.

In one embodiment, the step of reconciling the cNAV with the current NAV when the current NAV for the fund is available may include comparing the current NAV and the cNAV; and funding or debiting an account associated with the fund based on the comparison.

In one embodiment, the benchmark performance may be based on a NAV of the benchmark.

In one embodiment, the fund performance may be derived from movements in the fund's NAV.

In one embodiment, the fund performance and the benchmark performance may be compared over a period of time.

In one embodiment, the method may further include reconciling the cNAV with a current NAV when the current NAV for the fund is available.

In one embodiment, the method may further include funding or debiting an account based on a difference between the cNAV and the current NAV.

According to another embodiment, a system for contingency Net Asset Value pricing may include a first source of a daily Net Asset Value (NAV) for a fund; a second source of a performance data for a plurality of benchmarks; and a backend comprising at least one computer processor. The backend may receive receives the daily NAV for a fund from the first source; may receive the performance data from the second source; may select one of the plurality of benchmarks that has a benchmark performance that is similar to a fund performance of the fund for a period of time; may determine a correlation factor between the fund performance and the selected benchmark performance; and may calculate a cNAV based on a prior day's NAV for the fund, a movement for the selected benchmark, and the correlation factor in response to a daily NAV for the fund being unavailable.

In one embodiment, the selected benchmark may include one of an index and a commonly-traded instrument.

In one embodiment, the selected benchmark comprises one of the S&P 500 Index, the Dow Jones Industrial Average, the Hang Seng Index, the Nikkei 225 Index, the FTSE 100 Index, and the DAX Index.

In one embodiment, the backend may compare the current NAV and the cNAV; and fund or debit an account associated with the fund based on the comparison.

In one embodiment, the benchmark performance may be based on a NAV of the benchmark.

In one embodiment, the fund performance may be derived from movements in the fund's NAV.

In one embodiment, the fund performance and the benchmark performance may be compared over a period of time.

In one embodiment, the backend may reconcile the cNAV with a current NAV when the current NAV for the fund is available.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for contingency NAV pricing according to one embodiment; and

FIG. 2 depicts a method for contingency NAV pricing according to one embodiment.

### DETAILED DESCRIPTION OF PREFERRED EMBODIMENTS

The following documents are hereby incorporated, by reference, in their entireties: U.S. patent application Ser. No. 15/150,714 and U.S. Provisional Patent Application Ser. No. 62/159,558.

Embodiments are directed to systems and methods for Contingency NAV (cNAV) pricing. In the event of an upstream failure, embodiments may generate an approximate contingency price based on readily available public returns data on indices or traded instruments.

In embodiments, estimated values may be generated from a linear model based on highly correlated indices and commonly traded instruments, whose prices and returns are available independently.

In embodiments, a fund's historical returns may be adjusted for anomalous returns on distribution days and fund's split days. For example, the algorithm:

r_{F}=α+β^{T}r_{B}

may be used, where:

r_{F} represents the return of the benchmark calculation;

α represents movement of the fund;

β^{T} represents a correlation factor; and

r_{B} represents the return of the benchmark.

Using a pool of benchmarks, a benchmark that maximizes the correlation with the fund's returns may be selected as the first member of the optimal set. Next, subsequent benchmarks may be selected, one at a time, that maximize the marginal increase in correlation, while exceeding a specified threshold.

For example, every week, or as otherwise desired, the model may analyze the most recent two months of historical returns from the pool of the available benchmarks to determine the highest correlated predictors.

The predicators may then be used for the duration of the week, and every day the model coefficients are recalculated to produce the cNAVs.

Embodiments reduce the number of large breaches (+50 bps) from the actual NAV are reduced by approximately 90% compared to using the previous day NAV.

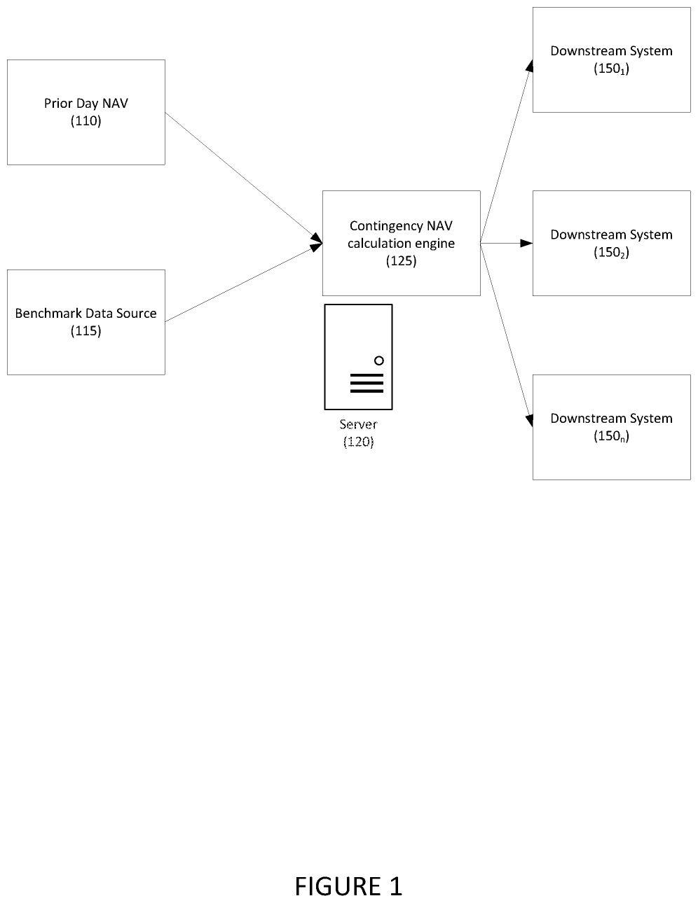

Referring to FIG. 1, a system for contingency NAV pricing is disclosed according to one embodiment. System 100 may include data sources, such a prior day NAV source 110 and benchmark data source 115. In one embodiment, prior day NAV 110 source may be a system that calculates the NAV for the fund, and provides the NAV contingency NAV calculation engine 125 executed by server 120.

Benchmark data source 115 may provide data for a plurality of benchmarks, such as indices, commonly-traded instruments, etc. Examples of benchmarks may include the S&P 500, Dow Jones Industrial Average, Hang Seng Index, Nikkei 225 Index, FTSE 100 Index, and DAX Index, etc.

Downstream systems 150 may include any NAV report dissemination platform for delivering final NAV values to clients and/or third party entities. Examples may include internal applications for report delivery, e-mail, FTP/SFTP, or facsimile transmissions, etc.

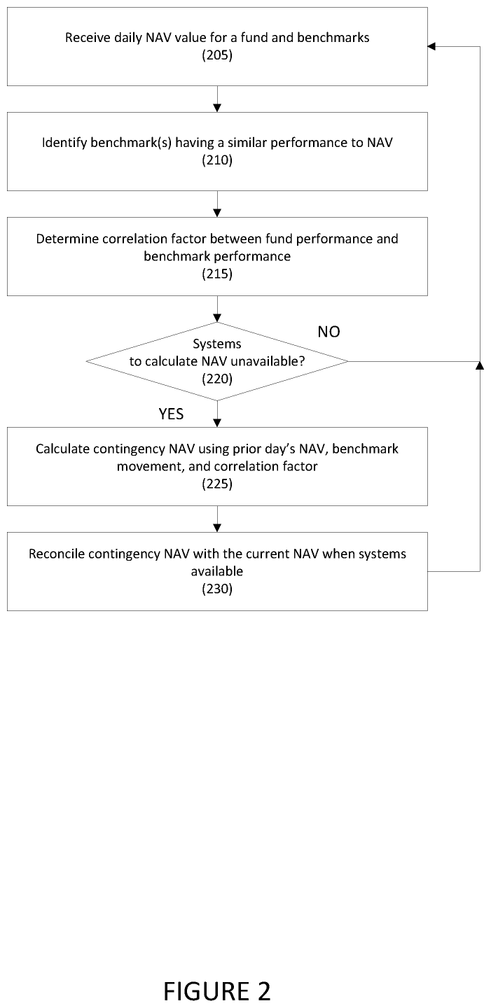

Referring to FIG. 2, a method for calculating a contingency NAV price is disclosed according to one embodiment.

In step 205, on a periodic basis (e.g., a daily basis), a fund's prior day NAV and a plurality of benchmarks may be received. Benchmarks may include indices, commonly-traded instruments, etc.

Examples of NAV calculation are disclosed in U.S. patent application Ser. No. 15/150,714, the disclosure of which is hereby incorporated by reference in its entirety.

In step 210, the performances of the benchmarks may be compared to the performance of the fund, and one or more benchmark that have the highest correlation with the fund may be identified as being a predictor of the fund's performance.

In one embodiment, the performance may be evaluated over a period of time, such as weeks, months, etc. in order to identify the benchmark(s) that have a performance that most closely correlates to the fund.

In one embodiment, the performance of the fund may be derived from the movements of the NAV price per share of the fund.

In step 215, a correlation factor between the benchmark(s) and the fund may be determined. For example, if it is determined that the performance of the fund correlates to 80% of the benchmark, the correlation value of 80% may be saved as a correlation factor.

In step 220, if the systems that are used to calculate the NAV are available, the process may be repeated, and the correlation factor may be refined on a daily basis.

If the systems that are used to calculate a NAV are unavailable, in step 225, the contingency NAV may be calculated using the prior day's NAV, the benchmark, and the correlation value. Thus, based on the example above, if the fund's performance correlated to 80% of the benchmark's performance, the contingency NAV will be calculated using the prior day's NAV, and adjusted using 80% of the benchmark's movement for the day.

In step 230, after the system become available, the calculated actual NAV is reconciled with the contingency NAV, and the process may be repeated.

For example, the actual NAV and the contingency NAV may be compared, and any adjustments based on subscriptions or redemptions, which were transacted using the contingency NAV, such as funding or debiting an account, may be performed.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for contingency Net Asset Value (cNAV) pricing, comprising:
in an information processing apparatus comprising at least one computer processor:
receiving a daily Net Asset Value (NAV) for a fund and performance data for a plurality of benchmarks;
selecting one of the plurality of benchmarks that has a benchmark performance that is similar to a fund performance of the fund for a period of time;
determining a correlation factor between the fund performance and the selected benchmark performance; and
calculating a cNAV based on a prior day's NAV for the fund, a movement for the selected benchmark, and the correlation factor in response to a daily NAV for the fund being unavailable.

2. The method of claim 1, wherein the selected benchmark comprises one of an index and a commonly-traded instrument.

3. The method of claim 1, wherein the selected benchmark comprises one of the S&P 500 Index, the Dow Jones Industrial Average, the Hang Seng Index, the Nikkei 225 Index, the FTSE 100 Index, and the DAX Index.

4. The method of claim 1, wherein the step of reconciling the cNAV with the current NAV when the current NAV for the fund is available comprises:
comparing the current NAV and the cNAV; and
funding or debiting an account associated with the fund based on the comparison.

5. The method of claim 1, wherein the benchmark performance is based on a NAV of the benchmark.

6. The method of claim 1, wherein the fund performance is derived from movements in the fund's NAV.

7. The method of claim 1, wherein the fund performance and the benchmark performance are compared over a period of time.

8. The method of claim 1, further comprising:
reconciling the cNAV with a current NAV when the current NAV for the fund is available.

9. The method of claim 8, further comprising:
funding or debiting an account based on a difference between the cNAV and the current NAV.

10. A system for contingency Net Asset Value (cNAV) pricing, comprising:
a first source of a daily Net Asset Value (NAV) for a fund;
a second source of a performance data for a plurality of benchmarks; and
a backend comprising at least one computer processor, wherein:
the backend receives the daily NAV for a fund from the first source;
the backend receives the performance data from the second source;
the backend selects one of the plurality of benchmarks that has a benchmark performance that is similar to a fund performance of the fund for a period of time;
the backend determines a correlation factor between the fund performance and the selected benchmark performance; and
the backend calculates a cNAV based on a prior day's NAV for the fund, a movement for the selected benchmark, and the correlation factor in response to a daily NAV for the fund being unavailable.

11. The system of claim 10, wherein the selected benchmark comprises one of an index and a commonly-traded instrument.

12. The system of claim 10, wherein the selected benchmark comprises one of the S&P 500 Index, the Dow Jones Industrial Average, the Hang Seng Index, the Nikkei 225 Index, the FTSE 100 Index, and the DAX Index.

13. The system of claim 10, wherein the backend further:
compares the current NAV and the cNAV; and
funds or debits an account associated with the fund based on the comparison.

14. The system of claim 10, wherein the benchmark performance is based on a NAV of the benchmark.

15. The system of claim 10, wherein the fund performance is derived from movements in the fund's NAV.

16. The system of claim 10, wherein the fund performance and the benchmark performance are compared over a period of time.

17. The system of claim 10, wherein the backend reconciles the cNAV with a current NAV when the current NAV for the fund is available.
